(19) United States
(12) Patent Application Publication
(10) Pub. No.: US 2012/0291106 A1
(43) Pub. Date: Nov. 15, 2012

(54) CONFIDENTIAL INFORMATION LEAKAGE PREVENTION SYSTEM, CONFIDENTIAL INFORMATION LEAKAGE PREVENTION METHOD, AND CONFIDENTIAL INFORMATION LEAKAGE PREVENTION PROGRAM

(75) Inventor: Takayuki Sasaki, Tokyo (JP)

(73) Assignee: NEC CORPORATION, Minato-ku, Tokyo (JP)

(21) Appl. No.: 13/522,898

(22) PCT Filed: Jun. 12, 2010
(86) PCT No.: PCT/JP2010/071838

§ 371 Date: Jul. 18, 2012

(30) Foreign Application Priority Data
Jan. 19, 2010 (JP) 2010-009124

(51) Int. Cl. G06F 21/00

(52) U.S. Cl. 726/5; 726/3

(57) ABSTRACT

Provided is a confidential information leakage prevention system in which a client 100 and a server 200 are configured to be capable of communicating with each other via a network, wherein the client 100 includes network access control unit 106 for controlling a network access request sent from an application program to the server 200, based on a security level assigned to this application program, and first authentication unit 107 for executing authentication processing of authenticating, with the server 200, that the network access control unit 106 is installed, and wherein the server 200 includes second authentication unit 202 for executing the authentication processing with the client 100, and permitting the network access request sent from the client when the authentication processing is successful.

### BACKGROUND

The present invention relates to technology for preventing the leakage of confidential information, and in particular relates to technology for preventing the leakage of confidential information using multi-level security.

Known is a multi-level security system (MLS) of assigning a label specifying the security level to access subjects and targets, and controlling the access to the access target based on the assigned label. This kind of multi-level security system assigns, for example, a label showing “public” or “confidential” to the application, and thereby controls the access from the application to a folder or the like. Examples of technology that apply this kind of multi-level security system to a network system are described in Patent Document 1 and Patent Document 2.

Patent Document 1 (Patent Publication JP-A-2004-220120) discloses a network system where, when a label showing the confidential level is assigned to a file in a client terminal and the client terminal sends the labeled file to the outside, the sending management program on the gateway server checks the label of the file, and sends the file to a network outside the organization when the confidential level is non-confidential.

Patent Document 2 (Patent Publication JP-A-2000-174807) discloses a configuration in which a computer system includes an operating system kernel for supporting the multi-level access control security mechanism to create object access packets.
[Patent Document 1] Patent Publication JP-A-2003-173284
[Patent Document 2] Patent Publication JP-A-2000-174807

When a multi-level security system is introduced by applying the configuration described in foregoing Patent Document 1 and Patent Document 2, since a configuration for assigning a label to the IP packet is newly required in the client terminal, there is a problem in that it is necessary to modify the operating system, the program providing network service or the like of the existing system.

### SUMMARY

Accordingly, an object of this invention is to provide a scheme for providing a network-compatible multi-level security system without having to modify the operating system or the like of the existing system.

The present invention is a confidential information leakage prevention system in which a client and a server are configured to be capable of communicating with each other via a network. The client includes a network access control unit for controlling a network access request sent from an application program to the server, based on a security level assigned to the application program, and a first authentication unit for executing authentication processing of authenticating, with the server, that the network access control unit is installed. The server includes a second authentication unit for executing the authentication processing with the client, and permitting the network access request sent from the client when the authentication processing is successful.

Moreover, the present invention is a confidential information leakage prevention method in a confidential information leakage prevention system in which a client and a server are configured to be capable of communicating with each other via a network. The client executes a control step of controlling a network access request sent from an application program to the server, based on a security level assigned to the application program, and a first authentication step of executing authentication processing of authenticating, with the server, that a network access control program for executing the control step is installed. The server executes a second authentication step of executing the authentication processing with the client, and a step of permitting the network access request sent from the client when the authentication processing is successful.

Moreover, the present invention is a program for causing a client, which is configured to be capable of communicating with a server via a network, to execute: a control step of controlling a network access request sent from an application program to the server, based on a security level assigned to the application program, and a first authentication step of executing authentication processing of authenticating, with the server, that a network access control program for executing the control step is installed, and causing the server to execute: a second authentication step of executing the authentication processing with the client, and a step of permitting the network access request sent from the client when the authentication processing is successful. Moreover, the present invention is also a computer-readable storage medium storing the foregoing program. The program of the present invention can be installed or loaded in a computer through various recording mediums such as a CD-ROM or other optical disks, a magnetic disk, or a semiconductor memory, or by being downloaded via a communication network or the like.

Note that the term “unit” as used in the present specification and the like does not simply refer to a physical unit, and also includes cases where the function of such unit is realized by software. Furthermore, the functions of one unit may be realized by two or more physical units, and the functions of two or more units may be realized by one physical unit.

According to the present invention, it is possible to provide a network-compatible multi-level security system without having to modify the operating system or the like of the existing system.

### DESCRIPTION OF THE DRAWINGS

FIG. 1 is a diagram showing the schematic configuration of the confidential information leakage prevention system according to the first embodiment.

FIG. 2 is a diagram showing an example of the hardware configuration of the confidential information leakage prevention system according to the first embodiment.

FIG. 3 is a diagram showing an example of the label assignment list.

FIG. 4 is a diagram showing an example of the data structure of the server information storage unit.

FIG. 5 is a diagram showing an example of the data structure of the access control rule storage unit.

FIG. 6 is a diagram showing an example of mounting the network monitoring unit.

FIG. 7 is a diagram showing an example of the data structure of the authentication-required server list.

FIG. 8 is a diagram showing an example of the authenticated client list.

FIG. 9 is a flowchart showing an example of the flow of the confidential information leakage prevention processing.

FIG. 10 is a flowchart showing an example of the flow of the authentication processing.

FIG. 11 is a diagram showing the schematic configuration of the confidential information leakage prevention system according to the second embodiment.

### DETAILED DESCRIPTION

The embodiments of the present invention are now explained with reference to the drawings. Note that the same elements are given the same reference numeral and redundant explanation thereof is omitted.

### [System Configuration]

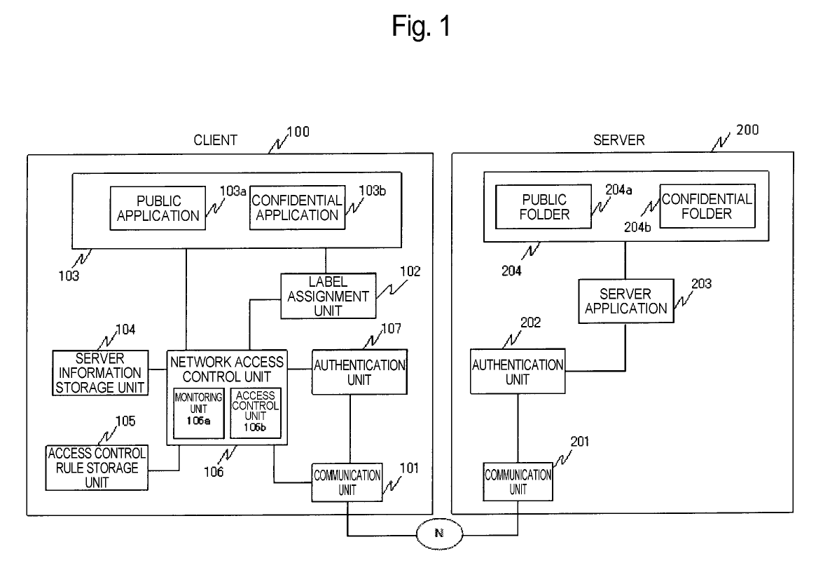

FIG. 1 is a block diagram showing the schematic configuration of the client/server system to which is applied the confidential information leakage prevention system according to this embodiment. This system includes a client 100 and a server 200, and the client 100 and the server 200 are mutually connected via a network N.

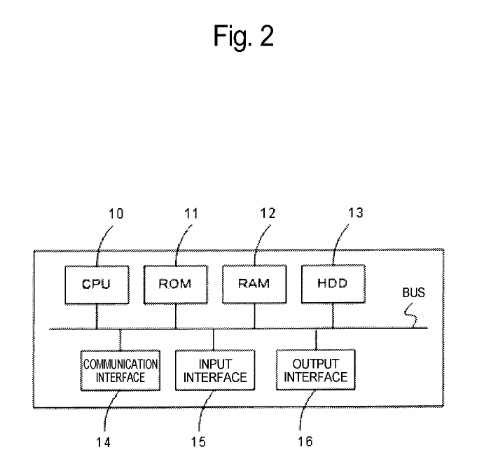

As the client 100, applied may be a general purpose computer comprising, as shown in FIG. 2, hardware such a CPU 10 as the control unit for controlling the processing and operation of the client 100, a memory such as a ROM 11 or a RAM 12, an external storage apparatus (HDD) 13 for storing various types of information, a communication interface 14, an input interface 15, an output interface 16 such as a display, and a bus for connecting the foregoing components. The ROM 11, the RAM 12 or the external storage apparatus 13 is also sometimes simply referred to as a storage apparatus. The client 100 can function as various function realizing units such as the label assignment unit 102, the network access control unit 106, and the authentication unit 107 described later as a result of the CPU 10 executing the predetermined programs stored in the memory or the external storage apparatus 13. Note that, although one client 100 is illustrated in FIG. 1, a plurality of clients 100 may be connected to the server 200, and the number of clients 100 may be suitably set according to the design. Moreover, although one server 200 is illustrated in FIG. 1, a plurality of servers 200 may be connected to the client 100, and the number of servers 200 may be suitably set according to the design.

The client 100 comprises communication unit 101, label assignment unit 102, an application 103 (public application 103a, confidential application 103b), server information storage unit 104, access control rule storage unit 105, network access control unit 106, and authentication unit 107.

The communication unit 101 is configured so as to communicate with the server 200 and other devices not shown via the network N, and input/output information, and is also referred to as a communication portion. For example, the communication unit 101 comprises an existing communication module such as a network interface card (NIC) or a TCP/IP driver.

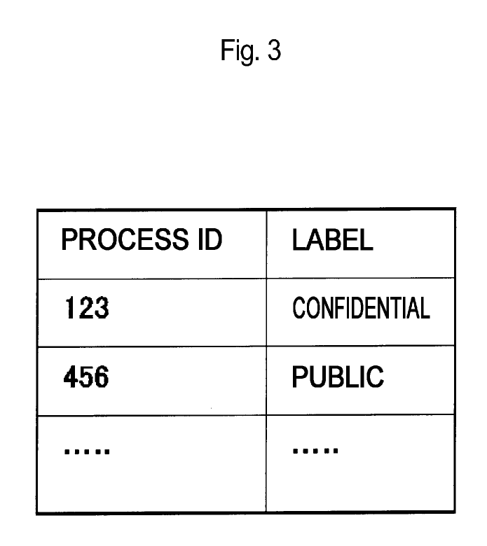

The label assignment unit 102 is configured so as to be able to assign, to the application 103, information (hereinafter referred to as the “label”) showing the security level, and is also referred to as a label assignment portion. Moreover, the label assignment unit 102 is configured so as to be able to store, in a predetermined storage area, a list (label assignment list) which associates the application 103 and a label assigned to that application 103. As the label, for example, two types of labels of “public” of low security and “confidential” of high security may be assigned, but the contents of the label are not limited thereto, and may be suitably set according to the design. FIG. 3 shows an example of the data structure of the label assignment list, and the correspondence of a process ID (process number) for uniquely identifying the application, an application name, and a label assigned to the application is stored.

Moreover, when the label assignment unit 102 receives an inquiry regarding the label assigned to a predetermined application from the network access control unit 106, the label assignment unit 102 is configured so as to be able to read the label assigned to that application from the label assignment list and notify the label. Moreover, the label assigned by the label assignment unit 102 can also be used upon prohibiting the distribution of information in the client 100 from the confidential application 103b to the public application 103a.

The application 103 (public application 103a and confidential application 103b) is application software that is stored in the external storage apparatus 13 or the like, and provides a predetermined function to the user by being executed by the CPU 10. There is no particular limitation as the application 103, but for example, existing software including an editor having a documentation function or a browser having an information perusal function may be applied, and in this embodiment, the application 103 is differentiated according to the contents of the label. In this embodiment, for example, the application 103 is differentiated as an application (public application) 103a to which a public label is assigned, and an application (confidential application) 103b to which a confidential label is assigned.

The server information storage unit 104 is a storage apparatus which associates and stores the access target of the application 103 and server information (also referred to as access target management information) on the label assigned to that access target, and includes a function as a database, and is also referred to as a server information storage portion. When the server information storage unit 104 receives a predetermined request including information for specifying the access target from the network access control unit 106, the server information storage unit 104 is configured to search the label assigned to that access target from the server information, and notify the search result to the network access control unit 106. Moreover, as the label that is assigned to the access target, the two types of “public” and “confidential” may be assigned, but without limitation thereto, other labels may be suitably set according to the design.

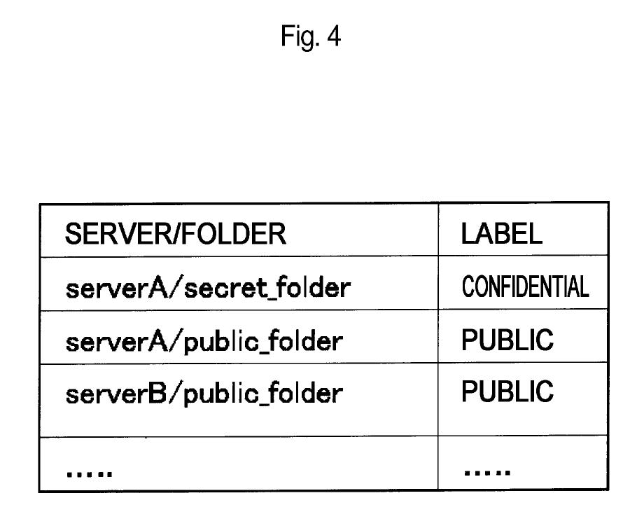

FIG. 4 shows an example of the data structure of the server information storage unit 104. As shown in this diagram, the server information storage unit 104 stores server/folder information, and “confidential” is assigned to the label when the access target is a confidential folder (server A/secret_folder) of the server A, and “public” is assigned to the label when the access target is a public folder (server A/public_folder B) of the server A. Note that the data structure of the server information storage unit 104 is not limited thereto, and, for example, an IP address may be used in substitute for the server name as information that can uniquely identify the server. In addition, when the security level is the two levels of “confidential” and “public”, it is possible to designate only the confidential folders, and deem all other folders to be the public folders.

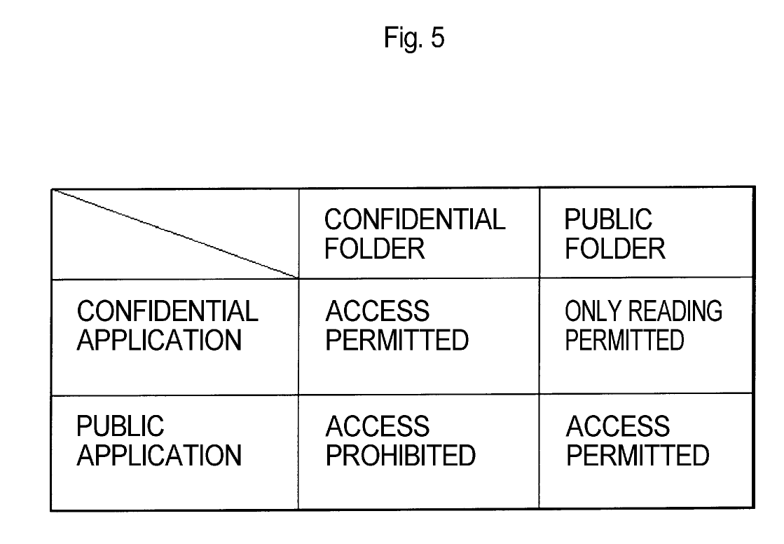

The access control rule storage unit 105 is a storage apparatus storing information (access control rule) for restricting access to the access target by the application 103, and is also referred to as an access control rule storage portion. While there is no particular limitation as the access control rule storage unit 105, for example, the respective access targets and the contents of the access control to those access targets are associated for each application and stored. The contents of control can be suitably set and changed according to the type or nature of access. FIG. 5 shows an example of the data structure of the access control rule storage unit. As shown in this diagram, as the confidential application, “access permitted” to the confidential folder and “only reading permitted” to the public folder are respectively associated and set. Meanwhile, as the public application, “access prohibited” to the confidential folder and “access permitted” to the public folder are respectively associated and set.

The network access control unit 106 includes a network monitoring unit 106a (hereinafter referred to as the “monitoring unit”) for monitoring the network communication to be executed via the communication unit 101, and an access control unit 106b for executing the access control to the application, and is also referred to as a network access control portion. The network access control unit 106 may be, for example, a program (network access control program) which is stored in the external storage apparatus 13 or the like, and provides the function of monitoring the network communication or the function of executing the access control to the application by being executed by the CPU 10.

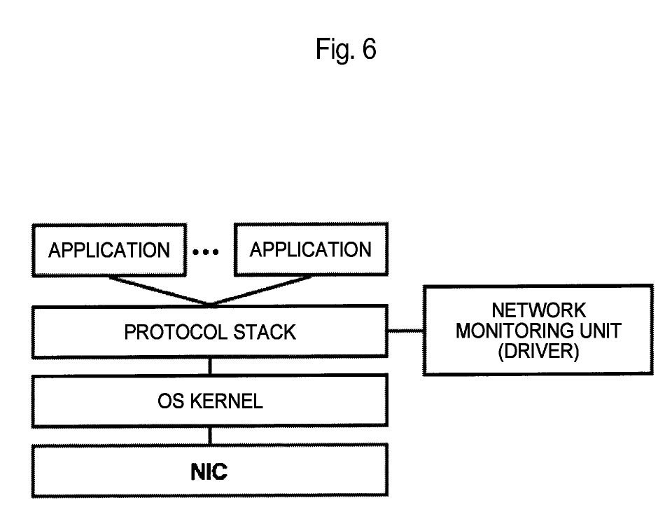

The monitoring unit 106a is used for monitoring all network accesses by the application 103, and is also referred to as a monitoring portion. The monitoring unit 106a can be realized by applying conventional technology of a filter driver such as a TDI (Transport Driver Interface) driver or an NDIS (Network Driver Interface Specification) driver. FIG. 6 is a diagram showing an example of the mounting of the monitoring unit 106a.

The access control unit 106b is configured so as to be able to execute the access control to the application when the monitoring unit 106a detects a network access by the application 103, and is also referred to as an access control portion. Specifically, the access control unit 106b extracts the application identifying information (for example, process ID) for identifying the application or the access target information (for example, file name) for identifying the access target from the detected access, and acquires the label of the application based on the process ID from the label assignment unit 102. Moreover, the access control unit 106b acquires the label of the access target (for example, folder) based on the access target information from the server information storage unit 104. Subsequently, the access control unit 106b performs the access control to the application 103 by referring to the access control rule from the access control rule storage unit 105 based on the acquired label of the application 103 and the label of the folder 204.

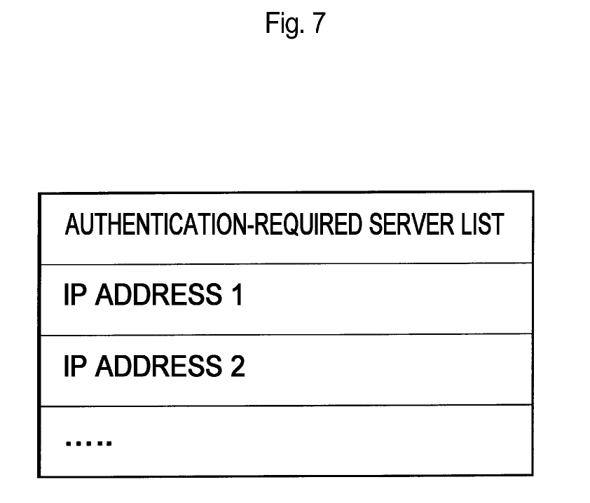

Moreover, the access control unit 106b is configured to store the list (authentication-required server list) of servers installed with the authentication unit 202 in a predetermined storage area, and determine whether authentication is required by referring to the authentication-required server list. FIG. 7 is a diagram showing an example of the data structure of the authentication-required server list. While there is no particular limitation in the structure of the authentication-required server list, for example, an IP address or DNS name is stored as the information capable of uniquely identifying the server.

Furthermore, the access control unit 106b stores, in a predetermined storage area, an authentication key for verifying that the network access control unit 106 is installed. The predetermined key is the same as the authentication key retained by the authentication unit 202 of the server 200.

The authentication unit 107 is used for authenticating that the network access control unit 106 is installed in the client 100, and is configured to be able to execute authentication processing with the server 200, and is also referred to as an authentication portion. The authentication unit 107 uses the authentication key retained by the network access control unit 106 and communicates with the authentication unit 202 of the server 200, and thereby performs the authentication processing. The authentication unit 107 notifies the results of the authentication processing to the network access control unit 106. While there is no particular limitation in the method of the authentication processing, as one example, authentication processing according to the challenge response system is executed here. Details of the authentication processing will be explained later.

Moreover, the authentication unit 107 is configured so as to be able to determine whether the network access control unit 106 is operating. While there is no particular limitation in the manner of determining whether the network access control unit 106 is operating, for example, an undergoing process list is acquired from the operating system, and whether the process ID of the network access control unit 106 is included in the acquired process list is confirmed.

The server 200 comprises communication unit 201, authentication unit 202, a server application 203, and a folder 204 (public folder 204a, confidential folder 204b). As the server 200, applied may be a general purpose server or computer comprising hardware such a CPU for controlling the processing and operation of the server 200, a memory such as a ROM or a RAM, an external storage apparatus for storing various types of information, a communication interface, an I/O interface, and a bus for connecting the foregoing components. Note that the hardware configuration of the server/computer is the same as the hardware configuration of the client 100 explained with reference to FIG. 2, and the explanation thereof is omitted.

The communication unit 201 is configured so as to communicate with the client 100 and other devices not shown via the network N, and input/output information, and is also referred to as a communication portion. For example, the communication unit 201 comprises an existing communication module such as a network interface card (NIC) or a TCP/IP driver.

The authentication unit 202 is configured so as to be able to execute authentication processing with the client 100 in order to authenticate that the network access control unit 106 is installed in the client 100, and is also referred to as an authentication portion. Specifically, the authentication unit 202 retains the same key as the authentication key retained by the network access control unit 106 of the client 100, and is configured to use this authentication key to communicate with the authentication unit 107 of the client, and perform authentication processing.

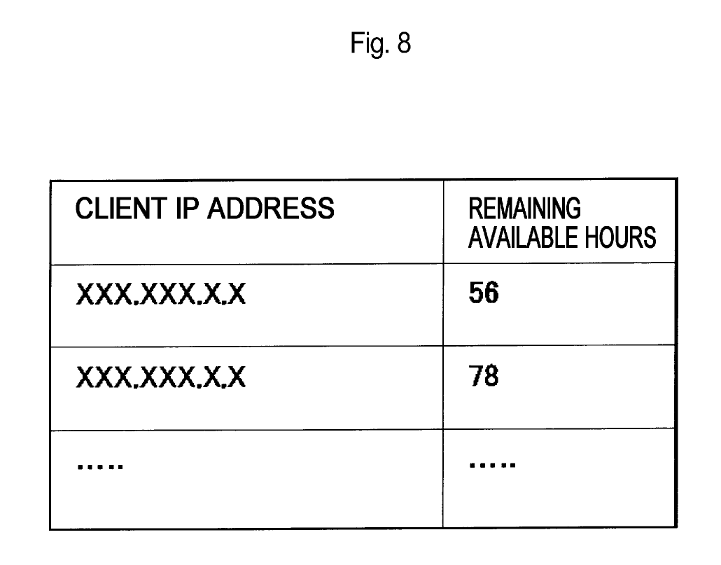

Moreover, the authentication unit 202 is configured to create a list (authenticated client list) of clients in which the authentication was successful. FIG. 8 is a diagram showing an example of the configuration of the authenticated client list. While there is no particular limitation in the data configuration of the authenticated client list, as shown in the diagram, an IP address of that client is stored as the identifying information for uniquely identifying the authenticated client. When the authentication of the client is successful, the authentication unit 202 adds that client to the authenticated client list. Note that, in FIG. 8, the available hours (remaining available hours) of that client as an authenticated client is also stored by being associated with the IP address. The remaining available hours will be explained later.

Moreover, the authentication unit 202 is configured to monitor the network access to the server application 203 and, upon detecting a network access, determine whether the client performing that network access is included in the authenticated client list, and decide whether to permit that network access based on the determination result. Specifically, when the client to perform the network access is included in the authenticated client list, the authentication unit 202 permits that network access, and, when the client to perform the network access is not included in the authenticated client list, prohibits that network access.

The server application 203 is a program for providing the network service, is stored in an external storage apparatus or the like, and executed by the CPU. While there is no particular limitation, for example, an existing program loaded with FTP or CIFS corresponds thereto.

The folder 204 is used for storing data to become the access target, and is also referred to as a directory. The folder 204 is differentiated by the label that is assigned, and in this embodiment, as one example, the folder 204 is differentiated into a folder (public folder) 204a to which a public label is assigned, and a folder (confidential folder) 204b to which a confidential label is assigned. In other words, public information is stored in the public folder, and confidential information is stored in the confidential folder. Note that the contents of the label are not limited thereto, and may be suitably set according to the design. The correspondence of the folder 204 and the label is stored in the server information storage unit 104 (FIG. 4).

Subsequently, the network N is a line for sending and receiving information between the client 100 and the server 200. The network N is, for example, the internet, dedicated line, packet communication network, telephone line, LAN, intranet, or other communication lines, or a combination of the foregoing lines, and may be wired or wireless.

### [Flow of Confidential Information Leakage Prevention Processing]

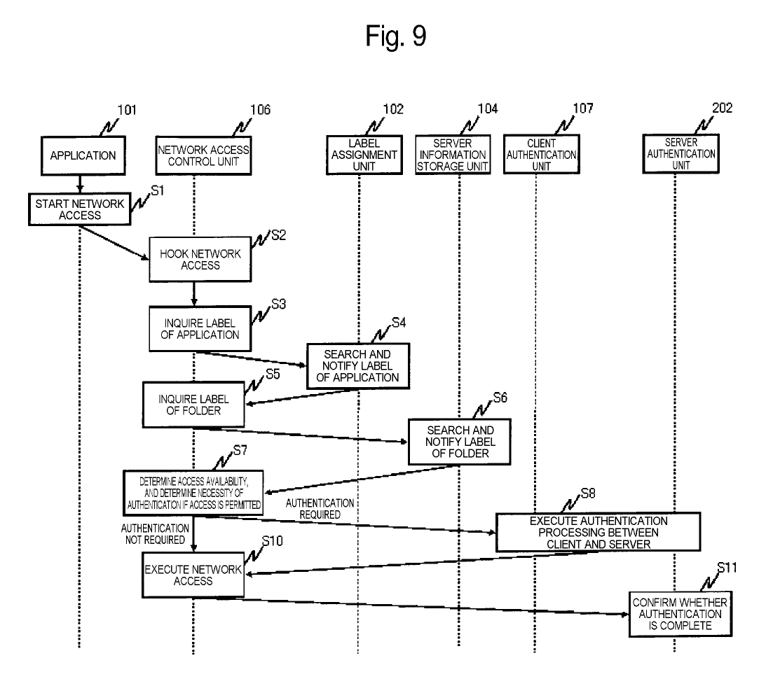

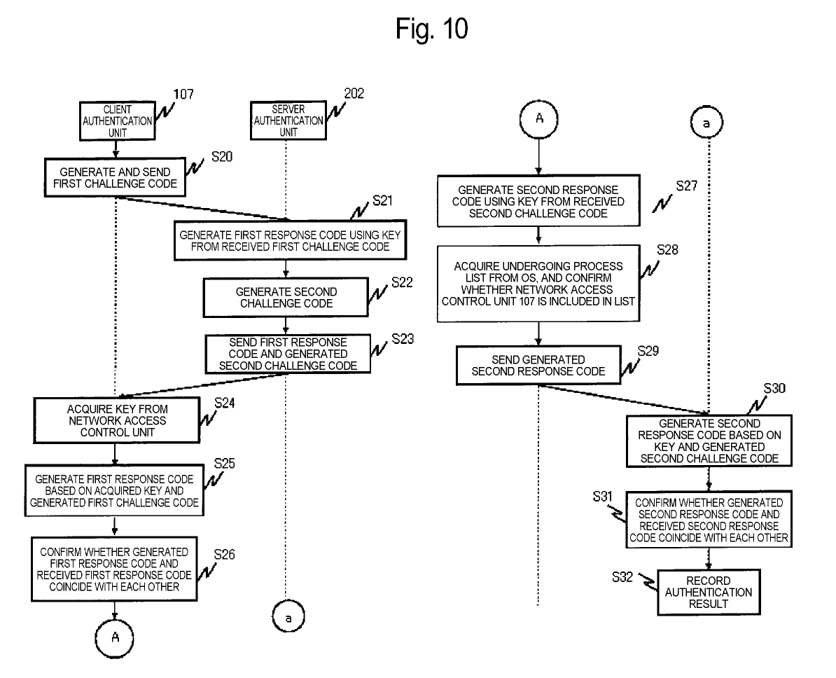

The confidential information leakage prevention processing according to this embodiment is now explained with reference to FIG. 9. Note that the order of the respective processing steps shown in FIG. 9 and FIG. 10 may be arbitrarily changed or the respective processing steps may be executed in parallel to an extent that will not cause any inconsistency in the processing contents. Moreover, other steps may be added between the respective processing steps. Moreover, a step that is indicated as one step for the sake of convenience may be executed by being separated into a plurality of steps. Meanwhile, steps that are indicated as a plurality of steps for the sake of convenience may be comprehended as one step.

As the premise, for example, let it be assumed that the monitoring unit 106a of the network access control unit 106 starts monitoring all network communications at a predetermined timing such as when the power is turned on.

The application 103 (103a or 103b) executed by the control unit (CPU) starts the access to an access target on a designated network, for example, according to instructions operated by the user (step S1).

The monitoring unit 106a of the network access control unit 106 hooks the network access (also referred to as a network access event) by the application 103 (103a or 103b) (step S2).

Subsequently, the access control unit 106b of the network access control unit 106 acquires, for example, the process number as the application information for identifying the application from the hooked access, and makes an inquiry to the label assignment unit 102 regarding the label of the application 103 (103a or 103b) that is attempting to perform the network access based on the foregoing process number (step S3).

The label assignment unit 102 searches the label assigned to the application 103 (103a or 103b) from the label assignment list (refer to FIG. 3), and notifies the search result to the access control unit 106b (step S4).

When the access control unit 106b acquires the label of the application 103 from the label assignment unit 102, the access control unit 106b acquires the access destination information for identifying the access destination from the hooked access, and makes an inquiry to the server information storage unit 104 based on the access destination information regarding the label that is assigned to the folder 204 (204a or 204b) of the access destination (step S5). For example, when the network access is file sharing, the server name and the folder name of the access destination can be acquired as the access destination information.

The server information storage unit 104 searches for the label of the folder identified by the access destination information from the internally stored database (refer to FIG. 4), and notifies the search result to the access control unit 106b (step S6).

When the access control unit 106b acquires the label of the application 103 (103a or 103b) and the label of the access destination, the access control unit 106b refers to the access control rule (refer to FIG. 5) stored in the access control rule storage unit 105, and determines whether the network access by the application is permitted (step S7).

For example, as shown in FIG. 5, when the application is a confidential label and the folder of the access destination is also of a confidential label, access is permitted. Moreover, when the application is a public label and the access destination folder is also a public label, access is permitted. When the application is a public label and the folder of the access destination is a confidential label, access is prohibited. Moreover, when the application is a confidential label and the folder of the access destination is a public label, only reading is permitted.

When access is permitted (including partial permission), the access control unit 106b determines whether authentication with the server 200 is required by determining, for example, whether the access destination is included in the authentication-required server list (refer to FIG. 7). When the access control unit 106b determines that the access destination is included in the authentication-required server list, the access control unit 106b determines that authentication is required, and requests authentication to the authentication unit 107 (step S7). Meanwhile, when the access destination is not included in the authentication-required server list, the access control unit 106b determines that authentication is not required, and permits the network access (step S10). Note that, in step S7, when the access is prohibited, the access control unit 106b ends the processing without determining whether the access destination is included in the authentication-required server list (refer to FIG. 7).

When an authentication request is issued by the access control unit 106b, the authentication unit 107 performs authentication processing with the server-side authentication unit 202 for authenticating whether the network access control unit 106 had been installed and is running. Details regarding the authentication processing will be explained later.

When the authentication regarding whether the network access control unit 106 had been installed and is running is successful between the client 100-side authentication unit 107 and the server 200-side authentication unit 202, the server 200-side authentication unit 202 adds that client 100 to the authenticated client list (step S8).

Moreover, the client 100-side authentication unit 107 notifies the access control unit 106b to the effect that the authentication was successful, and the access control unit 106b permits the network access as notified, and the application 103 performs network communication with the server application 203 of the server 200 (step S10).

Upon receiving an access (connection request) from the application 103, the server-side authentication unit 202 confirms whether the client 100 has been authenticated, and permits the access from the application 103 if the client 100 has been authenticated, and executes the hooked event (step S11). Meanwhile, if the authentication in step S8 ends in a failure, the authentication unit 202 determines that the client has not been authenticated, and prohibits the access from that application 103 (step S11).

Specifically, the server-side authentication unit 202 monitors the network access from the application to the server application 203, and, upon hooking (detecting) the access, confirms whether the client is included in the authenticated client list (refer to FIG. 8), permits the communication when the client is included and does not permit the communication when the client is not included (abandons the packet). For example, when the communication is being performed using an IP, communication is permitted when a source IP address is included in the authenticated client list, and communication is not permitted when the source IP address is not included.

When the server-side authentication unit 202 receives an access from a client in which the network access control unit 106 has not been installed, since the client 100 is not registered in the authenticated client list, access from that application 103 is prohibited since the client 100 has not been authenticated. When an access request containing the label of the application is received from a client to which conventional technology is applied, the server 200 may also processing that access according to the label based on the conventional technology.

### [Flow of Authentication Processing]

The authentication processing of step S8 is now explained in detail with reference to FIG. 10. Note that, in this embodiment, the case of performing mutual authentication based on the challenge response system is explained, but the authentication method is not limited thereto, and other authentication methods may be suitably adopted according to the design and other matters.

Foremost, the client 100-side authentication unit 107 generates a first challenge code, and sends the generated first challenge code to the server-side authentication unit 202. The first challenge code can be generated, for example, by using a random number (step S20).

When the server 200-side authentication unit 202 receives the first challenge code, the server 200-side authentication unit 202 uses the key stored in the server 200 and generates a first response code from the first challenge code (step S21). For example, a first response code can be obtained by using a hash function such as SHA1 or MD5 and converting the key and the first challenge code.

Subsequently, the authentication unit 202 generates a second challenge code (step S22). The second challenge code can be generated, for example, by using a random number.

The authentication unit 202 sends the generated first response code and the generated second challenge code to the client 100-side authentication unit 107 (step S23).

The client 100-side authentication unit 107 acquires a key from the network access control unit 106 (step S24).

In addition, the client 100-side authentication unit 107 generates a correct first response code from the first challenge code generated in S20 and the key acquired from the network access control unit 106 (step S25).

The client 100-side authentication unit 107 compares the correct first response code generated in S25 and the first response code received from the server 200-side authentication unit 202, and confirms whether the two first response codes coincide with each other (step S26).

If the two first response codes do not coincide, the client 100-side authentication unit 107 ends the processing since the authentication ended in a failure (not shown). If the two first response codes coincide with each other, the client 100-side authentication unit 107 generates a second response code in response to the second challenge code received from the server 200-side authentication unit 202 by using the key acquired from the network access control unit 106 (step S27). The authentication unit 107 can obtain the second response code, for example, by using a hash function such as SHA1 or MD5 and converting the key and the second challenge code.

Subsequently, the authentication unit 107 acquires an undergoing process list from the operating system, and determines whether the network access control unit 106 is operating by determining whether the network access control unit 106 is included in the process list based on the process ID of the network access control unit 106 (step S28).

When the determination result in step S28 is positive, the authentication unit 107 sends the second response code generated in S27 to the server 200-side authentication unit 202 (step S29). Meanwhile, when the determination result in step S28 is negative, the authentication unit 107 ends the processing since the authentication ended in a failure (not shown).

When the server 200-side authentication unit 202 receives the second response code, the server 200-side authentication unit 202 generates a correct second response code from the second challenge code generated in S22 and the key (step S30).

The server 200-side authentication unit 202 compares the generated correct second response code and the first response code received from the client 100-side authentication unit 107, and confirms whether the correct second response code and the first response code coincide with each other (step S31).

When the correct second response code and the first response code do not coincide, the authentication unit 202 ends the processing since the authentication ended in a failure (not shown). When the correct second response code and the first response code coincide with each other, the authentication unit 202 determines the authentication to be successful and adds the client 100 to the authenticated client list being authenticated. For example, when communication is being performed using an IP, the identifying information (for example, IP address, DNS name, machine name) for uniquely identifying the client 100 is recorded in the authenticated client list (refer to FIG. 8) (step S32).

According to the foregoing first embodiment, since the installation and operation of the network access control unit 106 in the client 100 are authentication between the client 100 and the server 200, it is possible to guarantee that the access control will be performed on the client 100 side. Consequently, it is no longer necessary to add a label to the packet on the client 100 side, and thereby possible to provide a network-compatible multi-level security system without having to modify the operation or the like.

Moreover, according to the first embodiment, the network access control unit 106 of the client 100 retains the key, and the key is delivered from the network access control unit 106 to the authentication unit 107 upon the authentication. Thus, the server 200 is able to more reliably authenticate that the network access control unit 106 is installed in the client 100.

Moreover, according to the first embodiment, since the authentication unit 107 of the client 100 confirms whether the network access control unit 106 is included in the process list of the operating system, in the authentication processing, it is possible to confirm whether the network access control unit 106 of the client 100 is operating.

### Modified Example of First Embodiment

In the foregoing explanation, only the server 200-side authentication unit 202 retained the authenticated client list, but the client 100-side authentication unit 107 may also retain an authenticated server list recorded with the IP address and name of the authenticated server 200. In the foregoing case, communication to an authenticated server can be conducted at a high speed by omitting the authentication process.

Moreover, the authenticated client list may also store the remaining available hours of the authentication as shown in FIG. 8. In the foregoing case, the server 200-side authentication unit 202 may subtract the available hours according to predetermined timing (for example, every second), and the authentication unit 202 may delete that entry from the list when the available hours become 0. Moreover, it is also possible to perform authentication processing once again before the available hours become 0, and thereby reset the available hours of authentication. In the foregoing case, since authentication is performed periodically, it is possible to prevent the legitimate client 100 and server 200 from being replaced by a fraudulent client or server.

Furthermore, the authenticated client list of the authentication unit 202 and the authenticated server list of the authentication unit 107 may also record the port number that is used by the application 103 of the client 100 in addition to recording the IP address and name. In addition, when the application 103 is ended and the network connection is disconnected, the entry may be deleted from the authenticated client list or the authenticated server list based on the port number. In the case of this operation, since re-authentication is performed only when the application 103 is communicating, it is possible to avoid unwanted re-authentication.

Moreover, in the foregoing explanation, a case of using two types of labels of “public” and “confidential” was explained, but two or more types of labels can also be used. For example, four types of labels such as “confidential”, “top secret”, “secret”, or “unclassified” may also be assigned. In the foregoing case, as with a general multi-level security system, the network access control unit 106 prohibits the distribution of information from an application 103 or folder 204 having a label of a low security level to an application 103 or folder 204 having a label of a high security level.

Furthermore, in the foregoing explanation, a case was explained where the network access control unit 106 permits the network access of the hooked application 103 in S10 of FIG. 9, but processing such as encryption and recording may also be performed according to the label. According to this configuration, it is possible to provide a system capable of controlling the security function according to the security level.

Moreover, in the foregoing explanation, a case was explained where the network access control unit 106 controls the reading and writing from and to the folder 204, but the contents of the network access control are not limited thereto. For example, in cases where the network access by the application is not reading or writing from or to a folder and is the sending or receiving of emails, the network access control unit 106 may control the sending and receiving of emails to that email address. Moreover, the network access control unit 106 may also control the communication to the process of the server 200.

Moreover, the configuration may also be such that a database storing the authentication-required server list of the network access control unit 106 and the label information of the folder of the server information storage unit 104 is defined for each user, and the logged-in user switches the authentication-required server list or the database. According to this operation, access control according to the user can be performed.

Moreover, the authentication unit 107 of the client 100 and the server 200-side authentication unit 202 may also confirm that the network access control unit 106 has not been falsified or the like at a predetermining timing during the authentication processing. While there is no particular limitation in the confirmation method, for example, the authentication unit 107 sends a hash value of the execution binary of the network access control unit 106 to the server 200-side authentication unit 202 at the timing of step S29 in FIG. 10. The server 200-side authentication unit 202 compares the hash value received from the authentication unit 107 and the hash value of the execution binary of the network access control unit 106 retained in advance, and determines whether the hash values coincide with each other. If the hash values coincide, the authentication unit 202 confirms that the network access control unit 106 has not be falsified. Meanwhile, if the hash values do not coincide, the authentication unit 202 determines that the network access control unit 106 has been falsified, and ends the processing since the authentication ended in a failure.

Moreover, in the foregoing explanation, a case was explained where the access control unit 106b retains the authentication-required server list, and determines the necessity of authentication by referring to such authentication-required server list, the method of determining the necessity of authentication is not limited thereto. For example, the access control unit 106b can also determine the necessity of authentication by using the server/folder information (refer to FIG. 4) retained by the server information storage unit 104. Specifically, the access control unit 106b acquires the server/folder information of the server of the access destination from the server information storage unit 104, and, if a confidential folder is included in the acquired folder information, determines that the server needs to be authenticated since that server is retaining a confidential folder.

Moreover, in the foregoing explanation, a case was explained where the authentication unit 107 confirmed the installation of the network access control unit 106 by a key and the operation of the network access control unit 106 by the process list, the authentication unit 107 may only confirm the installation of the network access control unit 106. Specifically, the authentication unit 107 may omit the processing in step S28 after executing the processing of step S27 of FIG. 10, and then execute the processing of step S29. According to the foregoing configuration, the authentication processing can be performed at a faster speed.

### Second Embodiment

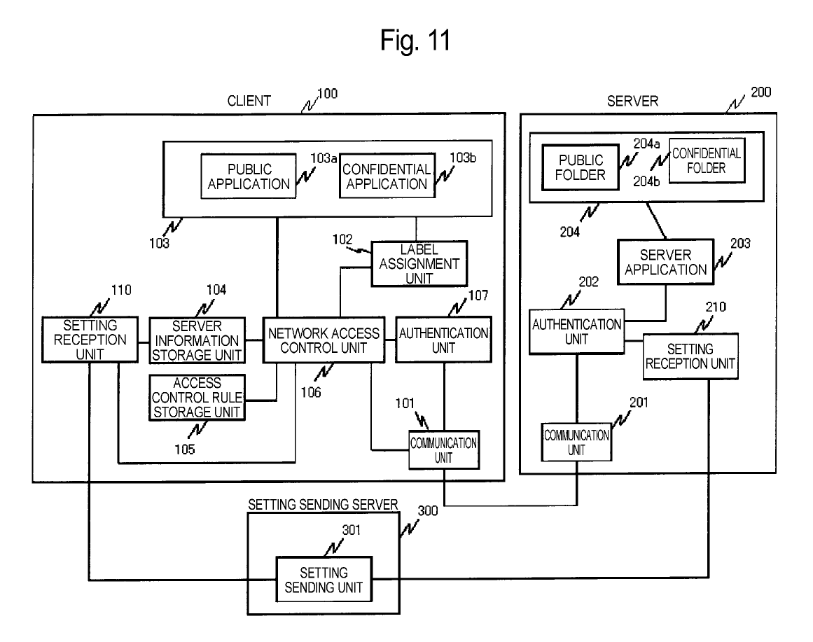

The second embodiment is now explained with reference to FIG. 11. The explanation of the same sections as the first embodiment is omitted. As shown in FIG. 11, the second embodiment differs from the first embodiment in that the client 100 further comprises setting reception unit 110, the server 200 further comprises setting reception unit 210, and the setting sending server 300 comprises setting sending unit 301.

The setting sending unit 301 of the setting sending server 300 is configured to respectively and internally store server information storing the database of the server information storage unit 104, an authentication-required server list of the network access control unit 106, and an authentication key of the network access control unit 106, and send the server information, the authentication-required server list and the key to the setting reception unit 110 of the client 100. Moreover, the setting sending unit 301 is configured to send the authentication key to the setting reception unit 210 of the server 200.

When the setting reception unit 110 of the client 100 receives the server information, the authentication-required server list and the key, the setting reception unit 110 updates the server information stored in the database of the server information storage unit 104, the authentication-required server list of the network access control unit 106, and the authentication key, respectively. Moreover, when the setting reception unit 210 of the server 200 receives the authentication key, the setting reception unit 210 updates the key retained by the authentication unit 202.

According to the second embodiment, the server information stored in the server information storage unit 104, the authentication-required server list of the network access control unit 106, and the authentication key can be respectively updated remotely. In particular, when there are a plurality of clients 100 and servers 200, the management can be streamlined.

This application relates to and claims priority from Japanese Patent Application No. 2010-9124, filed on Jan. 19, 2010, the entire disclosure of which is incorporated herein by reference.

The present invention was explained above with reference to the embodiments, but the present invention is not limited to the foregoing embodiments. The configuration and details of the present invention can be variously modified by those skilled in the art within the scope of the present invention.

The confidential information leakage prevention system, the confidential information leakage prevention method and the confidential information leakage prevention program according to the present invention are suitable for providing a network-compatible multi-level security system without having to modify the operating system or the like of the existing system.

10 . . . CPU, 11 . . . ROM, 12 . . . RAM, 13 . . . external storage apparatus, 14 . . . communication interface, 15 . . . input interface, 16 . . . output interface, 100 . . . client, 101 . . . communication unit, 102 . . . label assignment unit, 103 . . . application, 103a . . . public application, 103b . . . confidential application, 104 . . . server information storage unit, 105 . . . access control rule storage unit, 106 . . . network access control unit, 106a . . . monitoring unit, 106b . . . access control unit, 107 . . . authentication unit, 110 . . . setting reception unit, 200 . . . server, 201 . . . communication unit, 202 . . . authentication unit, 203 . . . server application, 204 . . . folder, 204a . . . public folder, 204b . . . confidential folder, 210 . . . setting reception unit, 300 . . . setting sending server, 301 . . . setting sending unit, N . . . network

1. A confidential information leakage prevention system in which a client and a server are configured to be capable of communicating with each other via a network,
wherein the client includes:
a network access control unit for controlling a network access request sent from an application program to the server, based on a security level assigned to the application program; and
a first authentication unit for executing authentication processing of authenticating, with the server, that the network access control unit is installed, and
wherein the server includes:
a second authentication unit for executing the authentication processing with the client, and permitting the network access request sent from the client when the authentication processing is successful.

2. The confidential information leakage prevention system according to claim 1,
wherein the first authentication unit executes the authentication processing with the second authentication unit by using a key retained by the network access control unit.

3. The confidential information leakage prevention system according to claim 1,
wherein the first authentication unit includes:
a first sending unit for sending, to the server, a first challenge code generated by using a first random number;
a first reception unit for receiving a first response code based on the first challenge code, and a second challenge code, that have been sent from the server;
a first response code generation unit for generating a first response code based on a first key retained by the network access control unit and the generated first challenge code;
a first determination unit for determining whether a first response code received by the first reception unit and a first response code generated by the first response code generation unit coincide with each other; and
a second sending unit for sending, to the server, a second response code generated from the second challenge code received by the first reception unit when the determination result by the first determination unit is positive, and
wherein the second authentication unit includes:
a third sending unit for sending, to the client, a first response code generated by using a second key retained by the second authentication unit from a first challenge code sent from the client, and a second challenge code generated by using a second random number;
a second reception unit for receiving a second response code based on the second challenge code sent from the client;
a second response code generation unit for generating a second response code based on the second key and the generated second challenge code; and
a second determination unit for determining whether a second response code sent from the client and a second response code generated by the second response code generation unit coincide with each other, and determining the authentication processing to be successful when the determination result is positive.

4. The confidential information leakage prevention system according to claim 1,
wherein the first authentication unit executes the authentication processing with the server on the condition that the network access control unit is operating.

5. The confidential information leakage prevention system according to claim 4,
wherein the first authentication unit acquires an undergoing process list from an operating system to confirm whether the network access control unit is included in the acquired process list, and thereby determines whether the network access control unit is operating.

6. A confidential information leakage prevention method in a confidential information leakage prevention system in which a client and a server are configured to be capable of communicating with each other via a network,
wherein the client executes:
a control step of controlling a network access request sent from an application program to the server, based on a security level assigned to the application program; and
a first authentication step of executing authentication processing of authenticating, with the server, that a network access control program for executing the control step is installed, and
wherein the server executes:
a second authentication step of executing the authentication processing with the client; and
a step of permitting the network access request sent from the client when the authentication processing is successful.

7. A program for causing a client, which is configured to be capable of communicating with a server via a network, to execute:
a control step of controlling a network access request sent from an application program to the server, based on a security level assigned to the application program; and
a first authentication step of executing authentication processing of authenticating, with the server, that a network access control program for executing the control step is installed, and
causing the server to execute:
a second authentication step of executing the authentication processing with the client; and
a step of permitting the network access request sent from the client when the authentication processing is successful.
